(19) United States
(12) Patent Application Publication
(10) Pub. No.: US 2019/0332986 A1
(43) Pub. Date: Oct. 31, 2019

(54) POST-MERGER/ACQUISITION INTEGRATION OF SYSTEMS AND PROCESSES USING A COMPARISON, RECOMMENDATION AND MIGRATION TOOL

(71) Applicant: INTERNATIONAL BUSINESS MACHINES CORPORATION, Armonk, NY (US)

(72) Inventors: Robert Thompson, Cary, NC (US); Charlene Frazier, Durham, NC (US); Jonathan Jackson, Cedar Grove, NC (US); Jenay Marbury, Morrisville, NC (US)

(21) Appl. No.: 15/966,310

(22) Filed: Apr. 30, 2018

(51) Int. Cl. G06Q 10/06

(52) U.S. Cl. CPC G06Q 10/0637; G06Q 10/06315

(57) ABSTRACT

Embodiments include method, systems and computer program products for comparing, recommending and migrating operations, systems and processes during a post-merger/acquisition integration (PMI). The method includes monitoring, using a processor, one or more operations, systems and/or processes related to at least two companies. The processor compares each of the operations, systems and/or processes to determine similarities and/or differences between the operations, systems and/or processes of the at least two companies. The processor further determines at least one superior operation, system and/or process in response to the comparison. The processor further provides a recommendation to transition to the at least one superior operation, system and/or process. The processor further migrates from at least one operation, system and/or process not recommended to the at least one superior operation, system and/or process.

### BACKGROUND

The present invention relates to mergers and acquisitions by companies, and more specifically, to implementing systems and processes determined to the better of redundant systems and processes between companies.

Mergers and acquisitions usually involve a process of combining two or more organizations into a single organization which may include several organizational systems, such as assets, people, resources, tasks, and the supporting information technology. The process of combining these systems is known as “integration”. Integration planning and execution can be challenging, especially when considering how best to proceed post integration in light of each company having dissimilar systems and processes.

### SUMMARY

Embodiments of the invention are directed to a method for comparing, recommending and migrating operations, systems and processes during a post-merger/acquisition integration (PMI). A non-limiting example of the computer-implemented method includes monitoring, using a processor, one or more operations, systems and/or processes related to at least two companies. The processor compares each of the operations, systems and/or processes to determine similarities and/or differences between the operations, systems and/or processes of the at least two companies. The processor further determines at least one superior operation, system and/or process in response to the comparison. The processor further provides a recommendation to transition to the at least one superior operation, system and/or process. The processor further migrates from at least one operation, system and/or process not recommended to the at least one superior operation, system and/or process.

Embodiments of the invention are directed to a computer program product that can include a storage medium readable by a processing circuit that can store instructions for execution by the processing circuit for performing a method for comparing, recommending and migrating operations, systems and processes during a post-merger/acquisition integration (PMI). The method includes monitoring one or more operations, systems and/or processes related to at least two companies. The processor compares each of the operations, systems and/or processes to determine similarities and/or differences between the operations, systems and/or processes of the at least two companies. The processor further determines at least one superior operation, system and/or process in response to the comparison. The processor further provides a recommendation to transition to the at least one superior operation, system and/or process. The processor further migrates from at least one operation, system and/or process not recommended to the at least one superior operation, system and/or process.

Embodiments of the invention are directed to a system. The system can include a processor in communication with one or more types of memory. The processor can be configured to monitor one or more operations, systems and/or processes related to at least two companies. The processor can be configured to compare each of the operations, systems and/or processes to determine similarities and/or differences between the operations, systems and/or processes of the at least two companies. The processor can be configured to determine at least one superior operation, system and/or process in response to the comparison. The processor can be configured to provide a recommendation to transition to the at least one superior operation, system and/or process. The processor can be configured to migrate from at least one operation, system and/or process not recommended to the at least one superior operation, system and/or process.

Additional technical features and benefits are realized through the techniques of one or more embodiments the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is an exemplary diagram of a distributed data processing system in which exemplary aspects of the present invention may be implemented;

FIG. 2 is a block diagram illustrating one example of a processing system for practice of the teachings herein;

FIG. 3 is a depiction of a sequence of comparing, recommending and migrating operations, systems and processes associated with an acquiring company and a target company during a post-merger integration (PMI) according to one or more embodiments; and

FIG. 4 is a flow diagram illustrating a method for comparing, recommending and migrating operations, systems and processes during a post-merger/acquisition integration (PMI) according to one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In accordance with exemplary embodiments of the disclosure, methods, systems, and computer program products for a post-merger/acquisition integration of systems and processes using a comparison, recommendation and migration tool is described herewith.

Turning now to an overview of technologies that are more specifically relevant to aspects of the invention, embodiments of the invention are related in general to post integration management of systems and processes. Often when a company is merged into or acquired by another company, combining components of the companies is difficult because the companies tend to have different systems and processes. Some differences can include code deployment, communication protocols, approval processes, life cycle support etc. Currently, when determining how best to proceed with systems and processes between the companies, a manual process is employed where systems and processes are examined by an integration team (i.e., a team from the acquiring company along with a team from the target company) to compare and contrast, each system and process in order to determine the most appropriate system and/or process to be deployed by the integration team for use by the combined organization. The compare and contrast is usually based on information gleaned from questionnaires or others types of forms completed by each company. Accordingly, the integration process is often tedious and time consuming. In addition, the selection of systems and processes can be subjective, often in favor of the acquiring company.

Turning now to an overview of aspects of the present invention, one or more embodiments of the invention provide methods, systems, structures and computer program products configured to compare, recommend and migrate systems and processes during a post-merger/acquisition integration (PMI) period. A PMI tool can be used to monitor operations, systems and processes of both an acquiring company and a target company at associated endpoints. The PMI tool can identify processes, applications, tools, protocols, procedures and the like, used by the acquiring company and the target company and compare those processes, applications, tools, protocols, and procedures implemented by the acquiring company to the processes, applications, tools, protocols, and procedures implemented by the target company. The PMI tool can recommend which processes, applications, tools, protocols, and procedures should continue to be used after integration is completed. Upon confirmation, data associated with the processes, applications, tools, protocols, and procedures that have not been recommended can be prepared for migration to the recommended processes, applications, tools, protocols, and procedures. The processes, applications, tools, protocols, and procedures not recommended can be sunset after migration.

The above-described aspects of the invention address the shortcomings of the prior art by actively comparing, recommending and migrating operations, systems and processes associated with an acquiring company and a target company in a more efficient and objective manner. The invention can also assist in preparing applications, tools, protocols, and procedures not recommended to be sunset.

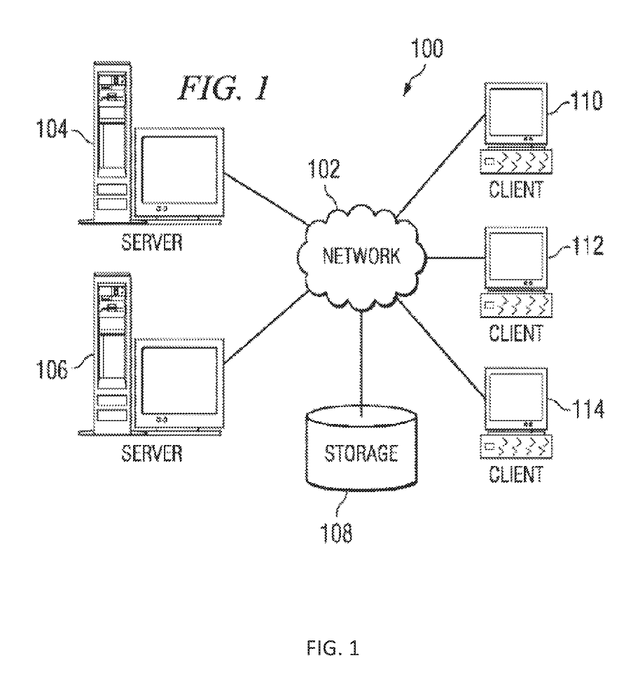

With reference now to the figures, FIG. 1 depicts a pictorial representation of an exemplary distributed data processing system in which aspects of the illustrative embodiments of the present invention may be implemented. Distributed data processing system 100 may include a network of computers in which embodiments of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown. Servers 104 and 106 can be associated with different companies, for example, an acquiring company and a target company.

In the depicted example, distributed data processing system 100 is the Internet with network 102 representing a worldwide collection of networks and gateways that can use a variety of communication protocols (e.g., Transmission Control Protocol/Internet Protocol (TCP/IP)) to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the exemplary embodiments of the present invention may be implemented.

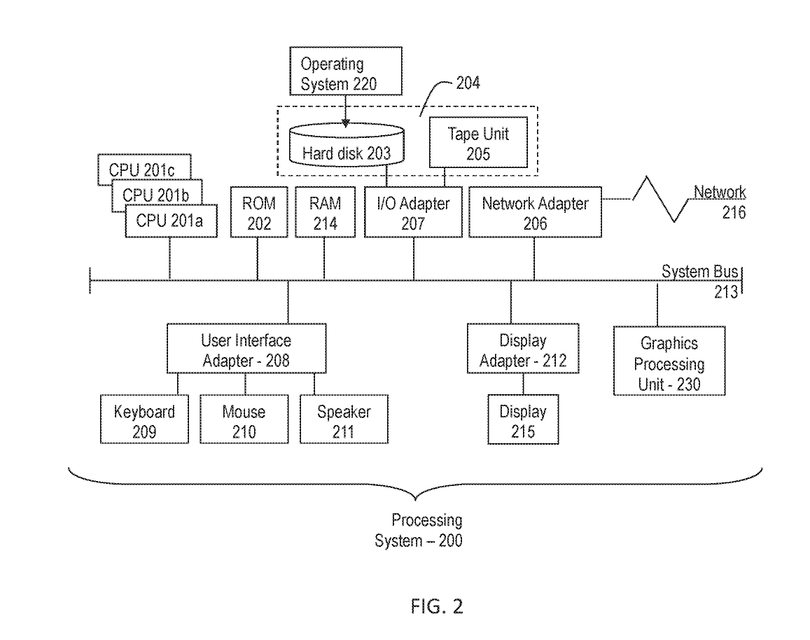

With reference now to FIG. 2, a block diagram of an exemplary processing system 200 is shown in which aspects of the exemplary embodiments of the present invention may be implemented. Processing system 200 is an example of a computer, such as server 104 or client 110 in FIG. 1, in which computer usable code or instructions implementing the processes for exemplary embodiments of the present invention may be located. In this embodiment, the processing system 200 has one or more central processing units (processors) 201a, 201b, 201c, etc. (collectively or generically referred to as processor(s) 201). In one embodiment, each processor 201 may include a reduced instruction set computer (RISC) microprocessor. Processors 201 are coupled to system memory 214 and various other components via a system bus 213. Read only memory (ROM) 202 is coupled to the system bus 213 and may include a basic input/output system (BIOS), which controls certain basic functions of system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or tape storage drive 205 or any other similar component. I/O adapter 207, hard disk 203, and tape storage device 205 are collectively referred to herein as mass storage 204. A network adapter 206 interconnects bus 213 with an outside network 216 enabling data processing system 200 to communicate with other such systems. A screen (e.g., a display monitor) 215 is connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 are all interconnected to system bus 213 via user interface adapter 208, which may include, for example, a Super I/O chip integrating multiple device adapters into a single integrated circuit.

In exemplary embodiments, the processing system 200 includes a graphics processing unit 230. Graphics processing unit 230 is a specialized electronic circuit designed to manipulate and alter memory to accelerate the creation of images in a frame buffer intended for output to a display. In general, the graphics processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system 220.

The operating system 220 essentially controls the execution of other computer programs by the processor 201 and provides scheduling, input-output control, file and data management, memory management, and communication control and related services. The operating system 220 also coordinates and provides control of various components within the processing system 200. As used by a client, for example, client 110, the operating system 220 may be a commercially available operating system, for example, UNIX, Linux, Windows, or the like. A user interacting with the processing system 200 through operating system 220 can use a command-line interface/interpreter, i.e., a shell. The user can control the operation of the processing system 200 by entering commands as text for the command line interpreter to execute, or by creating text (shell scripts) of one or more such commands.

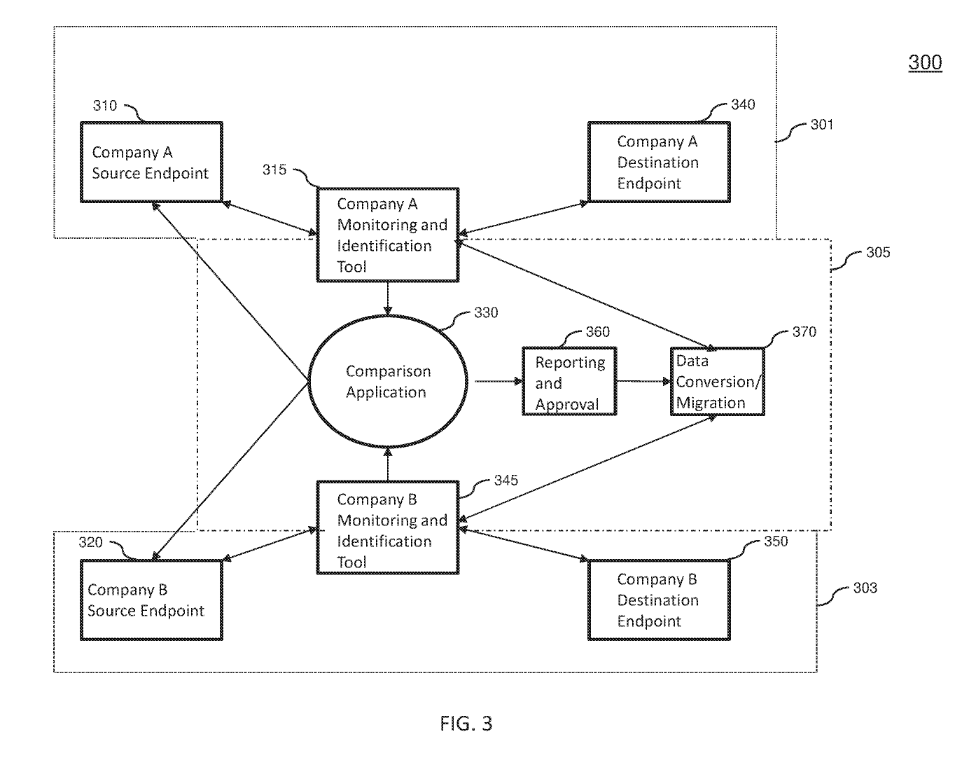

FIG. 3 depicts a sequence 300 of comparing, recommending and migrating operations, systems and processes associated with an acquiring company and a target company during a post-merger integration (PMI) according to one or more embodiments. During a PMI between company A 301 and company B 303 a comparison, recommendation and migration tool 305 (PMI tool) can be used to assist integration teams associated with both company A 301 and company B 303 to identify common operations, systems and processes, compare the common operations, systems and processes, recommend operations, systems and processes deemed superior based on the comparison, and prepare data associated with the inferior operations, systems and processes for migration to the superior operations, systems, and processes, and conduct the migration.

After a merger or acquisition between company A 301 and company B, an integration team can utilize the PMI tool 305 to objectively assess which operations, systems and processes should be used after integration between company A 301 and company B 303 is complete. Accordingly, the integration team can use the PMI tool 305 to launch and install monitoring and identification tools 315 and 345 within the infrastructures of company A 301 and company B 303 to monitor source endpoints 310 and 320, and destination endpoints 340 and 350, respectively. The source endpoints 310 and 320 can include, for example, servers and/or cloud platforms. The source endpoints 310 and 320 can include, for example, points at which one or more end users can initiate one or more actions (e.g., a change record). The destination endpoints 340 and 350 can include, for example, employee workstations, source control, build machines, web servers, email service, change control, support, security compliance, certifications or the like. Each monitoring and identification tool can include various tracking and data collection applications for example, a keylogger, to collect data on how operations, systems, and processes (e.g., code deployment, communication protocols, approval processes, life cycle support, inventory lists, equipment, operating systems, etc.) are used and/or implemented by company A 301 and company B 303. For example, monitoring and identification tools 315 and 345 could each track communications, program(s) used to perform job duties, typical work schedules, and various work habits for company A 301 and company B 303, respectively. The monitoring and identification tools 315 and 345 can be used for a predetermined period of time, for example, 6 months, to dynamically learn each operation, system, and process implemented by company A 301 and company B 303, respectively. The period of time can be based on a variety of factors, for example, size of company A 301 and company B 303, how much equipment is being monitored, how many operations and processes are being monitored, complexity of the systems, operations and processes implemented by company A 301 and company B 303, respectively, or the like. The monitoring and identification tools 315 and 345 can each maintain a threshold of data needed before transmitting information to a comparison application 330. The threshold of data can be configurable depending on types of data to be identified. For example, a statistical average of 10 data points collected over 3 months could be used as the threshold.

Upon obtaining a requisite amount of data about the operations, systems and processes for company A 301 and company B 303, the data can be sent to comparison application 330 to determine similarities and/or differences between the operations, systems, and processes for company A 301 and company B 303. The similarities and/or differences can be determined in response to metrics associated with the operations, systems and processes for company A 301 and company B 303 related to, for example, performance, usage, likability, costs, maintenance, down time, square footage needed, age, complexity, turnaround time, initial response time, number of defects per functional area, number of audit findings by severity or the like.

The similarities and/or differences between the operations, systems, and processes of company A 301 and company B 303 can be output by a reporting and approval module 360. The reporting and approval module 360 can also include recommendations regarding superior operations, systems, and processes, timeframes and schedules for transitions to the superior operations, systems and processes by company A 301 or company B 303, costs for the transition to the superior operations, systems and processes, designate priorities for transitioning the superior operations, systems and processes, suggestions on how to merge teams and/or resources, identify operations, systems and processes not common to both companies, or the like. The reporting and approval module 360 can also include an approval/disapproval portion to obtain input from the integration team regarding whether each of the recommendations provided by the reporting and approval module 360 has been approved or disapproved.

In response to the approval or disapproval of each of the recommendations provided by the reporting and approval module 360, a data conversion/migration module 370 can prepare data associated with any of the inferior operations, systems and processes for migration to the superior operations, systems, and processes. The preparation can entail, for example, formatting the data, changing user account information, converting certifications, obtaining certifications, or the like. The data conversion/migration module 370 can also assist in migrating data associated with the inferior operations, systems and processes to the superior operations, systems and processes. The data conversion/migration module 370 can also assist with the sunset of the inferior operations, systems, and processes. In addition, the data conversion/migration module 370 can make adjustments to the inferior operations to bring them in-line with the superior operations. For example, the data conversion/migration module 370 can add alerts to the inferior operations for additional actions to be performed in-line with the superior operations, provide an additional interface(s) in order to replace or upgrade equipment, or the like.

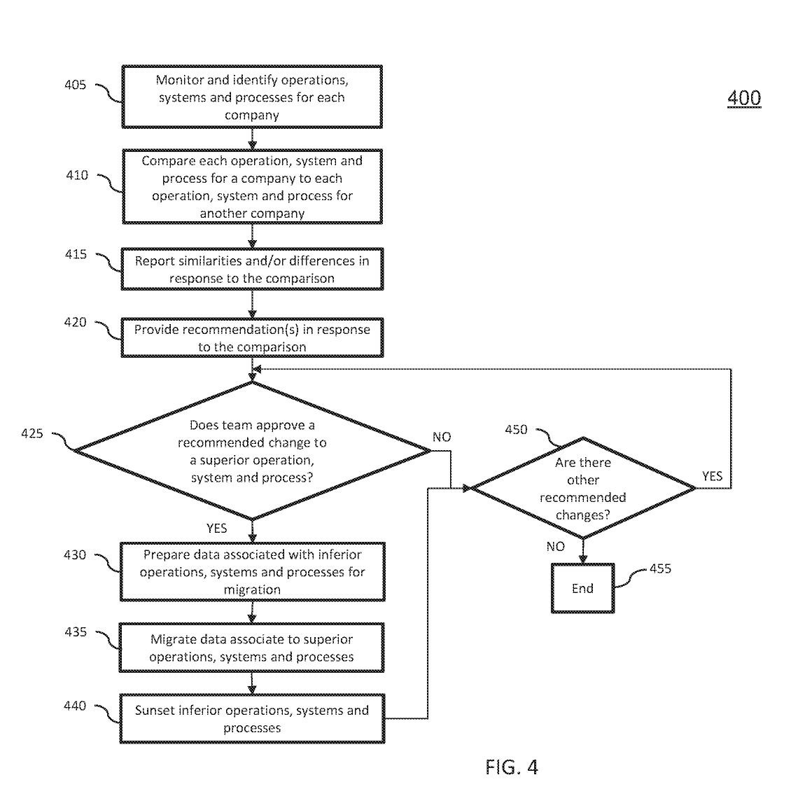

FIG. 4 is a flow diagram 400 illustrating a computer-implemented method for comparing, recommending and migrating operations, systems and processes during a post-merger/acquisition integration (PMI) according to one or more embodiments of the present invention. At block 405, the computer-implemented method monitors operations, systems and processes for each company involved in the PMI and identifies how operations, systems, and processes are used and/or implemented. At block 410, the operations, systems, and processes for each company involved in the PMI, and how those operations, systems and processes are used and/or implemented are compared. At block 415, based on the comparison, the computer-implemented method can report similarities and/or differences between common operations, systems, and processes and note operations, systems and processes that are not common to the companies being compared. At block 420, the computer-implemented method can provide a recommendation to the integration team based on the comparison. The recommendation can be related to an indication of operations, systems and processes deemed superior based on the comparison, timeframes and schedules for transitions to the superior operations, systems and processes, costs for the transition, designate priorities for transitioning the superior operations, systems and processes, and suggestions on how to merge teams and/or resources.

At block 425, the computer-implemented method can determine whether the integration team approves the recommended change from an inferior operation, system, and process to a superior operation, system and/or process. If the integration team does not approve the recommended change, the method proceeds to block 450. If the integration team does approve the recommended change, the computer-implemented method proceeds to block 430 where data associated with the inferior operation, system and/or process can be prepared for the transition to the superior operation, system, and process. For example, the preparation can entail formatting the data, changing user account information, converting certifications, obtaining certifications, or the like. At block 435, the computer-implemented method can utilize the prepared data to migrate from the inferior operation, system and/or process to the superior operation, system and/or process. At block 440, upon migration to the superior operation, system and/or process, the inferior operation, system and/or process can be sunset/retired.

At block 450, the computer-implemented method can determine whether additional changes to operations, systems and/or processes have been recommended. If additional changes are recommended, the computer-implemented method returns to block 425. If additional changes are not recommended, the computer-implemented method ends at block 455.

Embodiments of the present invention can assist in transitioning to superior operations, systems and/or processes based on a comparison between companies involved in a post-merger/acquisition. Embodiments of the present invention can also assist in the migration to the superior operations, systems and/or processes, as well as sunsetting operations, systems and/or processes deemed inferior.

Embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for comparing, recommending and migrating operations, systems and processes during a post-merger/acquisition integration (PMI), the method comprising:
monitoring, using a processor, one or more operations, systems and/or processes related to at least two companies;
comparing, using the processor, each of the operations, systems and/or processes to determine similarities and/or differences between the operations, systems and/or processes of the at least two companies;
determining, using the processor, at least one superior operation, system and/or process in response to the comparison;
providing, using the processor, a recommendation to transition to the at least one superior operation, system and/or process; and
migrating, using the processor, from at least one operation, system and/or process not recommended to the at least one superior operation, system and/or process.

2. The computer-implemented method of claim 1, further comprising sunsetting the at least one operation, system and/or process not recommended in response to the migration to the at least one superior operation, system and/or process.

3. The computer-implemented method of claim 1, further comprising preparing data associated with the at least one operation, system and/or process not recommended for migration to the at least one superior operation, system and/or process in response to an approval of the recommendation.

4. The computer-implemented method of claim 1, wherein the at least one operation, system and/or process is at least one of: code deployment, communication protocols, approval processes, life cycle support, inventory lists, equipment, and operating systems.

5. The computer-implemented method of claim 1, wherein the monitoring occurs at one or more endpoints associated with one of the at least two companies.

6. The computer-implemented method of claim 1, wherein the determination of similarities and/or differences is related to at least one of: performance, usage, likability, costs, maintenance, down time, square footage needed, age, and complexity.

7. The computer-implemented method of claim 1, wherein the recommendation further includes at least one of: timeframes and schedules for a transition to the superior operation, system and/or process, costs for the transition to the superior operation, system and/or process, a designation of priorities for transitioning to the superior operation, system and/or process, suggestions on how to merge teams and/or resources, and an identification of operations, and systems and processes not common to the at least two companies.

8. A computer program product for comparing, recommending and migrating operations, systems and processes during a post-merger/acquisition integration (PMI), the computer program product comprising:
a computer readable storage medium having stored thereon first program instructions executable by a processor to cause the processor to:
monitor one or more operations, systems and/or processes related to at least two companies;
compare each of the operations, systems and/or processes to determine similarities and/or differences between the operations, systems and/or processes of the at least two companies;
determine at least one superior operation, system and/or process in response to the comparison;
provide a recommendation to transition to the at least one superior operation, system and/or process; and
migrate from at least one operation, system and/or process not recommended to the at least one superior operation, system and/or process.

9. The computer program product of claim 8, further comprising sunsetting the at least one operation, system and/or process not recommended in response to the migration to the at least one superior operation, system and/or process.

10. The computer program product of claim 8, further comprising preparing data associated with the at least one operation, system and/or process not recommended for migration to the at least one superior operation, system and/or process in response to an approval of the recommendation.

11. The computer program product of claim 8, wherein the at least one operation, system and/or process is at least one of: code deployment, communication protocols, approval processes, life cycle support, inventory lists, equipment, and operating systems.

12. The computer program product of claim 8, wherein the monitoring occurs at one or more endpoints associated with one of the at least two companies.

13. The computer program product of claim 8, wherein the determination of similarities and/or differences is related to at least one of: performance, usage, likability, costs, maintenance, down time, square footage needed, age, and complexity.

14. The computer program product of claim 8, wherein the recommendation further includes at least one of: timeframes and schedules for a transition to the superior operation, system and/or process, costs for the transition to the superior operation, system and/or process, a designation of priorities for transitioning to the superior operation, system and/or process, suggestions on how to merge teams and/or resources, and an identification of operations, and systems and processes not common to the at least two companies.

15. A system, comprising:
one or more processors; and
at least one memory, the memory including instructions that, upon execution by at least one of the one or more processors, cause the system to perform a method for comparing, recommending and migrating operations, systems and processes during a post-merger/acquisition integration (PMI), the method comprising:
monitoring one or more operations, systems and/or processes related to at least two companies;
comparing each of the operations, systems and/or processes to determine similarities and/or differences between the operations, systems and/or processes of the at least two companies;
determining at least one superior operation, system and/or process in response to the comparison;
providing a recommendation to transition to the at least one superior operation, system and/or process; and
migrating from at least one operation, system and/or process not recommended to the at least one superior operation, system and/or process.

16. The system of claim 15, further comprising sunsetting the at least one operation, system and/or process not recommended in response to the migration to the at least one superior operation, system and/or process.

17. The system of claim 15, further comprising preparing data associated with the at least one operation, system and/or process not recommended for migration to the at least one superior operation, system and/or process in response to an approval of the recommendation.

18. The system of claim 15, wherein the at least one operation, system and/or process is at least one of: code deployment, communication protocols, approval processes, life cycle support, inventory lists, equipment, and operating systems.

19. The system of claim 15, wherein the monitoring occurs at one or more endpoints associated with one of the at least two companies.

20. The system of claim 15, wherein the determination of similarities and/or differences is related to at least one of: performance, usage, likability, costs, maintenance, down time, square footage needed, age, and complexity.
